(19) United States
(12) Patent Application Publication
(10) Pub. No.: US 2014/0202505 A1
(43) Pub. Date: Jul. 24, 2014

(54) Improvements in or relating to Vehicle Washing Methods and Apparatus

(71) Applicants: Philip Anthony Cotton, Waitakere (NZ); James Ballard Shelling, Auckland (NZ)

(72) Inventors: Philip Anthony Cotton, Waitakere (NZ); James Ballard Shelling, Auckland (NZ)

(73) Assignee: PCS HOLDINGS LIMITED, Auckland (NZ)

(21) Appl. No.: 14/232,789

(22) PCT Filed: Jul. 13, 2012
(86) PCT No.: PCT/NZ2012/000123

§ 371 Date: Mar. 20, 2014

(30) Foreign Application Priority Data
Jul. 15, 2011 (NZ) 594099

(51) Int. Cl. B60S 3/04; E04H 5/02

(52) U.S. Cl. CPC B60S 3/04; E04H 5/02
USPC 134/57 R; 29/428; 52/79.1

(57) ABSTRACT

Disclosed is a vending apparatus for vehicle washing that is self contained and can be moved from one desired location to another. The apparatus has a washing housing, with a floor, at least two walls mounted to or from opposing sides of the floor. The two walls define an entrance aperture and an exit aperture to allow passage of a vehicle, onto the floor, and out. The washing apparatus is contained within the washing housing and is automated to wash a vehicle when a vehicle. The washing housing has a support surface to engage with and support it above the ground, and at least one engagement point for a prime mover to allow movement of the apparatus from said location to another. Also there is a customer interface to authorise and activate washing of a vehicle. The washing housing can be located in a first location via the prime mover to allow washing of vehicles, and then when required can be easily moved via the prime mover to another location.

### BACKGROUND OF INVENTION

The present invention relates to a mobile self-contained vending apparatus and method for washing vehicles.

Commercial wash facilities exist for vehicles that allow a user to pay for a vehicle wash and drive their vehicle into the wash facility. Thereafter an automated wash system will wash the vehicle and then the vehicle is driven out of the wash facility. The wash facility normally is of a hall type arrangement which a vehicle can drive into and out of, with washing apparatus contained inside the hall.

Presently commercial wash facilities for vehicles, for example those in petrol stations, specific vehicle cleaning locations or similar are permanently located onsite. There are a number or reasons for this permanent location.

Commercial vehicle wash facilities are often built onsite at lowest cost possible from basic building materials. A concrete pad is laid and has permanent connections for water supply and cleaning chemicals and drainage for the dirty fluids from washing. Electrical connections are also permanent and laid to the pad. A shell is then erected from basic building materials to house the wash apparatus. The washing apparatus and control system is then installed inside this shell. A separate customer interaction location is also provided.

It is uneconomical to move such a facility once created because of the nature of the construction and materials. They are heavy and only designed to withstand loading when in place. In other words it lacks the structural integrity to raise it off the ground and move it to a new location.

Moving such a structure is also often simply not possible because of its connection with the surrounding ground, for example the concrete pad that is in place.

Some systems available may be pre-fabricated off-site and delivered onsite in an erected or partially erected state. A shell is then erected on site from the parts. However these systems still require a dedicated prepared site into which the system can be located, including plumbing in and out and electrical, control connections and concrete or similar base pad. Once erected the washing apparatus and control system is then installed inside this shell.

Such facilities are still not designed to be quickly lifted and moved from their present location to another more convenient location, again either because of their bulk, lack of structural integrity and/or economics.

At the very best for all such commercial wash facilities described the washing apparatus can be removed and reused and the remaining shell is then either knocked down, moth-balled or used for a different purpose.

Existing systems have further economic disadvantages. The installation of existing commercial wash facilities requires an investment in land and the investment in the building and installation of the wash facility. Typically a single auto wash facility not including land has a capital cost upwards of NZ$300,000. This presents risk to the owner of the land, the operator of the wash facility and the owner of the wash facility. The owner of the land may have to pay towards the facility regardless of whether it is used or not, the operator has costs that have to be met by use of the facility and the owner of the wash facility has to pay for the facility cost.

If for any reason there is insufficient custom for the wash facility then the fixed and running costs of the facility are not met and become a financial burden rather than an asset for the various parties.

Further the permanent location of such commercial wash facilities is inflexible and cannot react to meet demand. Also for example water restrictions may prevent or restrict operation of such facilities for certain parts of the year, for example in summer.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### OBJECTS OF THE INVENTION

It is therefore an object of the present invention to provide improvements in or relating to vehicle washing methods and apparatus which at least go some way to overcoming the disadvantages of the prior art, or at least ameliorate the above problems or at least will provide the public with a useful choice.

Further objects of the invention will become apparent from the following description.

### BRIEF SUMMARY OF THE INVENTION

In a first aspect the present invention consists in vending apparatus for vehicle washing that is substantially self contained and is adapted to be moved from one desired location to another as required, comprising or including,
a washing housing, said washing housing including,
   a floor, and
   at least two walls mounted to or from opposing sides of said floor, said at least two walls defining an entrance aperture and an exit aperture of said washing housing to allow passage of a vehicle, into said washing housing via said entrance aperture, onto and across said floor, and out of said washing housing via said exit aperture,
   washing apparatus substantially contained within said washing housing that is automated to wash a vehicle when a vehicle is located in said washing housing,
   a support surface or surfaces that depend from said washing housing to engage with and support said vehicle wash apparatus substantially above a ground or other surface it is located on,
   at least one engagement point for a prime mover to allow movement of said apparatus from said location to another,
   a customer interface to allow a customer to authorise and activate washing of a vehicle, and
water treatment apparatus at least in part contained in said washing housing, wherein said water treatment apparatus includes at least one baffle for fluid to flow under, and at least one weir for fluid to flow over,
wherein said washing housing can be located in a first location via said prime mover to
allow washing of vehicles, and then when required can be easily moved via said prime mover to another location.

Preferably there is at least one connection point for fluid supply, fluid removal, power, telemetry/telecommunications and control for said washing housing and washing apparatus.

Preferably said vending apparatus has at least any one of more of the following on board fluid supply, fluid removal, power, telemetry/telecommunications and control for said washing housing and washing apparatus.

Preferably said apparatus is assembled initially from a largely flat pack condition.

Preferably said vending apparatus before or after location in said desired location can be moved as a substantially erected self-contained vending apparatus.

Preferably said self contained washing apparatus can be moved substantially as one piece from one desired location to the next.

Alternatively said washing housing consists of at least two halves that split along a centrally located vertical plane running from said entrance aperture to said exit aperture to allow for easy transport of said vending apparatus from one location to another.

Preferably said authorisation is by paying, or authorising payment to be made.

Preferably said entrance aperture is defined by an aperture through a first of said at least two walls (“first end wall”), and said exit aperture is defined by another aperture through a second of said at least two walls (“second end wall”).

Preferably said washing housing has a roof to at least partially enclose said washing housing from above.

Preferably there are additional walls that enclose said washing housing save for said entrance aperture and said exit aperture.

Preferably said washing housing is substantially rectangular in plan form.

Preferably said washing housing has at least one of an entrance ramp and an exit ramp.

Preferably at least one of said entrance ramp or exit ramp has a first position and a second position, wherein said first position allows access or exit of a vehicle into or from said washing housing, and wherein said second position disallows access or exit from said washing housing.

Preferably said second position said entrance ramp and/or exit ramp substantially close said entrance aperture and said exit aperture respectively.

Alternatively, or in addition, one or more of said entrance aperture or exit aperture are closed by a door or doors.

Preferably said apparatus has a connection or connections, either wired or wireless for telephone or internet communications.

Preferably said customer interface is on one side of said entrance aperture.

Alternatively said customer interface is located near said entrance aperture.

Preferably said washing apparatus is of a touchless variety that has no physical contact with said vehicle to be washed, save for fluid spraying onto said vehicle.

Alternatively said washing apparatus is of a friction variety that at least in part has contact with said vehicle to be washed, for example it is a brushed type apparatus.

Preferably there is at least one waste fluid collection channel running from at or near said entrance aperture toward said exit aperture, said at least one waste fluid collection channel being fed fluids at least from said floor after washing said vehicle.

Preferably said at least one waste fluid collection channel runs substantially underneath said floor.

Preferably said water treatment apparatus includes water storage means.

Preferably said water treatment apparatus is substantially contained under said floor.

Preferably said at least one baffle or weir form at least one tank.

Preferably there are a plurality of tanks in said water treatment apparatus.

Preferably said water treatment apparatus at least in part is located in two said collection channels running parallel to each other either side of said floor.

Preferably said two channels are connected at at least one end thereof to form one channel.

Preferably there is at least one cover to cover said channel(s).

Preferably said prime mover is a crane and said at least one engagement point allows said crane to engage said vending apparatus and lift it onto a second location, for example a second prime mover (e.g. a truck and/or trailer) to move it to another location.

Preferably there are four said at least one engagement points for said crane, one at or toward each corner of each said half of said washing housing.

Alternatively said vending apparatus has wheels, tracks, skids or similar that engage with said ground or other surface and said prime mover tows said vending apparatus to another location via said at least one engagement point.

Preferably said vehicle to be washed is stationary when being washed and a part of said washing apparatus moves to wash said vehicle.

Alternatively said vehicle to be washed is mobile when being washed, either under its own or external power (for example being driving by the user, or using a moving portion of said floor).

Preferably said fluid supply and said fluid removal is to and from a water storage, reclaiming and recycling apparatus.

Preferably said water storage, reclaiming and recycling apparatus is contained substantially within said washing housing.

Alternatively some or all of said water storage, reclaiming and recycling apparatus is contained substantially within a building separate to said washing housing

Preferably there is a said at least one connection point at or near each corner of said washing housing.

Preferably said washing housing is substantially fully enclosed, at least when washing said vehicle, such that a minimum of fluids and washing debris escape said apparatus.

Preferably said apparatus is self-contained and requires no additional connections thereto for normal operation.

In a further aspect the present invention may be said to consist in a method of vehicle wash vending, comprising or including the steps of,
1. locating a self contained vending apparatus for vehicle washing in a desired location via one or more prime movers,
2. connecting any utilities required,
3. locating in place or attaching any vehicle access ramps to and from said vending apparatus, and (may use onside concrete),
4. commissioning said vending apparatus by at least, powering up said self contained vending apparatus,
   thereafter said self contained vending apparatus is in place to allow a user to wash a vehicle as required, when the location is no longer convenient or another location is desired the self contained vending apparatus can be
5. moved by reversing the above steps,
   wherein said self contained vending apparatus comprises or includes,
   a washing housing to substantially contain a vehicle when being washed, said washing housing including,
      an entrance aperture thereto and
      an exit aperture therefrom for said vehicle, and
      washing apparatus substantially contained within said washing housing that is automated to wash said vehicle when said vehicle is located in said washing housing.

Preferably said apparatus has any one or more of the following utilities on board fluid supply, fluid removal, power, control or telemetry/telecommunication, for example there maybe an onboard generator.

Preferably said method includes, prior to step 1, the step of assembling said apparatus from a largely flat pack condition, where after, before or after location in said desired place it can be moved as a self contained vending apparatus.

Preferably said utility connections where external of said apparatus are required are of at least one of fluid supply, fluid removal, power, control or telemetry to said self contained vending apparatus.

Preferably said self contained washing apparatus can be moved substantially as one piece from one desired location to the next.

Preferably said washing housing consists of two parts that split along a centrally located vertical plane running from said entrance aperture to said exit aperture to allow for easy transport of said self contained vending apparatus from one location to another.

Preferably said vehicle access ramps fold down from said vending apparatus to allow access thereto.

Preferably said vehicle access ramps can fold up and close said entrance aperture and said exit aperture when said self contained vending apparatus is not in use, for example overnight, in-between washes.

Alternatively, or in addition, one or more of said entrance aperture or exit aperture are closed by doors.

Preferably said step of making utilities connections includes making a connection or connections, either wired or wireless for telephone or internet communications for said self contained vending apparatus.

Preferably said step of making utilities connections includes making said fluid supply and fluid removal connections to a water storage, reclaiming and recycling apparatus.

In yet a further aspect the present invention consists in a transportable carwash bay for vehicle washing that is substantially self contained and is adapted to be moved from one desired location to another as required, comprising or including,
a washing housing, said washing housing including,
   a floor, and
   at least two walls mounted to or from opposing sides of said floor, said at least two walls defining at least in part an entrance aperture and an exit aperture of said washing housing to allow passage of a vehicle, into said washing housing via said entrance aperture, onto and across said floor, and out of said washing housing via said exit aperture,
   washing apparatus substantially contained within said washing housing, whether fed internally or externally of said washing housing, that is automated to wash a vehicle when a vehicle is located in said washing housing,
   a support surface or surfaces that depend from said washing housing to engage with and support said vehicle wash apparatus substantially above a ground or other surface it is located on,
   at least one engagement point for a prime mover to allow movement of said apparatus from said location to another,
   a customer interface to allow a customer to authorise and activate washing of a vehicle,
wherein said washing housing can be located in a first location via said prime mover to allow washing of vehicles, and then when required can be easily moved via said prime mover to another location.

In a further aspect the present invention may be said to consist in a kit of parts for a vending apparatus for vehicle washing, whether in flat pack and/or partially assembled form, wherein said kit enables assembly of a washing housing comprising or including,
a floor, and
at least two walls able to be mounted to or from opposing sides of said floor, said
at least two walls when assembled defining an entrance aperture and an exit aperture of said washing housing to allow passage of a vehicle, into said washing housing via said entrance aperture, onto and across said floor, and out of said washing housing via said exit aperture,
washing apparatus substantially contained within said washing housing that is automated to wash a vehicle when a vehicle is located in said washing housing,
a support surface or surfaces that depend from said washing housing to engage with and support said vehicle wash apparatus substantially above a ground or other surface it is located on,
at least one engagement point for a prime mover to allow movement of said apparatus from said location to another,
a customer interface locatable in or on an external surface of said washing housing or closely located thereto to allow a customer to authorise and activate washing of a vehicle,
wherein said washing housing once assembled can be located in one location via said prime mover to allow washing of vehicles, and then when required can be easily moved via said prime mover to another location.

Preferably said kit also includes frame work for said vending apparatus.

Preferably said kit includes washing fluids, powders or similar for said vending apparatus.

In yet a further aspect still the present invention consists in vending apparatus for vehicle washing as herein described with reference to any one or more of the accompanying drawings.

In yet a further aspect still the present invention consists in a method of vehicle wash vending as herein described with reference to any one or more of the accompanying drawings.

In still yet another aspect the present invention consists in a transportable carwash bay for vehicle washing as herein described with reference to any one or more of the accompanying drawings.

In yet another aspect still the present invention consists in a kit of parts for a vending apparatus for vehicle washing as herein described with reference to any one or more of the accompanying drawings.

Further aspects of this invention which should be considered in all its novel aspects will become apparent from the following description given by way of example of a possible embodiment thereof.

As used herein the term “and/or” means “and” or “or”, or both.

As used herein “(s)” following a noun means the plural and/or singular forms of the noun. The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner. It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Other aspects of the invention may become apparent from the following description which is given by way of example only and with reference to the accompanying drawings.

### BRIEF DESCRIPTION OF THE DRAWINGS

Preferred embodiments of the present invention are shown in the accompanying drawings, whereby:

FIG. 1: is a isometric plan view of the car washing apparatus with a roof removed so the interior is visible and the ramps present or deployed for vehicle access into and out of the washing apparatus;

FIG. 2: is a perspective view of the entrance to the washing apparatus showing the entrance aperture and customer interface and entrance ramp together with the floor and a partial view of the washing apparatus;

FIG. 3: is a ground level entrance end perspective view of the washing apparatus similar to that of FIG. 2;

FIG. 4: is an interior floor level perspective view looking out the exit aperture showing part of the washing apparatus and the exit aperture;

FIG. 5: is a left hand side partial perspective view through a side wall and the glazing thereon showing the interior of the wash facility and exit aperture;

FIG. 6: is a plan view of the entrance end of the washing facility showing the covered areas that house the mechanisms and storage for the washing apparatus;

FIG. 7: is an interior view similar to that of FIG. 4 with the exception it is looking out the entrance aperture and shows the covers for mechanisms of the washing apparatus;

FIG. 8: shows a entrance end ground level perspective view of the washing facility in use including a vehicle inside the washing apparatus and a vehicle waiting to enter, together with the customer interface to allow for payment and activation of the washing cycle;

FIG. 9: is a right hand side perspective view similar to that of FIG. 8 showing a vehicle in the wash facility and a vehicle waiting for a wash;

FIG. 10: shows a similar view to that of FIG. 9 showing the entrance and exit ramps and the exit aperture,

FIG. 11a: interior view towards one end of a variation of the present embodiment showing some equipment storage locations behind operator cowl's and optional shower, noise, spray, or waterproof or tamperproof doors;

FIG. 11 b: shows a similar view to FIG. 11a with n operator cowl removed showing the equipment and the door opened;

FIG. 12: this is a similar view to FIG. 11a showing the opposite side of the operator cowl in place protecting equipment;

FIG. 12b: is a similar view to that of FIG. 12a with the operator cowl removed showing equipment;

FIG. 13: shows a close-up of an area of floor with covering removed to provide some or all the storage tanks and/or cleansing apparatus and similar;

FIG. 14: is a interior view of one side of the apparatus showing covers for the water storage reclaiming and recycling apparatus;

FIG. 15: is a similar view to that of FIG. 14 with the covers removed;

FIG. 16: is an interior view toward one end showing the locations either side of one option for water storage reclaiming and recycling apparatus either side of the area the vehicle moves through, in one variation one side may contain water storage (either fresh or soiled or both for example half being fresh and half being soiled) and the other side may have the reclaiming and recycling apparatus, or any variation thereof;

FIG. 17: is an interior view showing the covers removed to reveal the water storage and the reclaiming and recycling apparatus;

FIG. 18: shows an external view with a ramp folded up showing one variation of the actuation means for opening and closing the ramps;

FIG. 19: shows a prime mover in this instance as a truck and trailer unit;

FIG. 20: shows a second prime mover lifting the vending apparatus off the first prime mover and locating it into position; and

FIG. 21: shows a partially assembled vending apparatus that has been assembled at least in part from a flat pack or as being disassembled down to a partial flat pack.

### DETAILED DESCRIPTION OF PREFERRED EMBODIMENTS

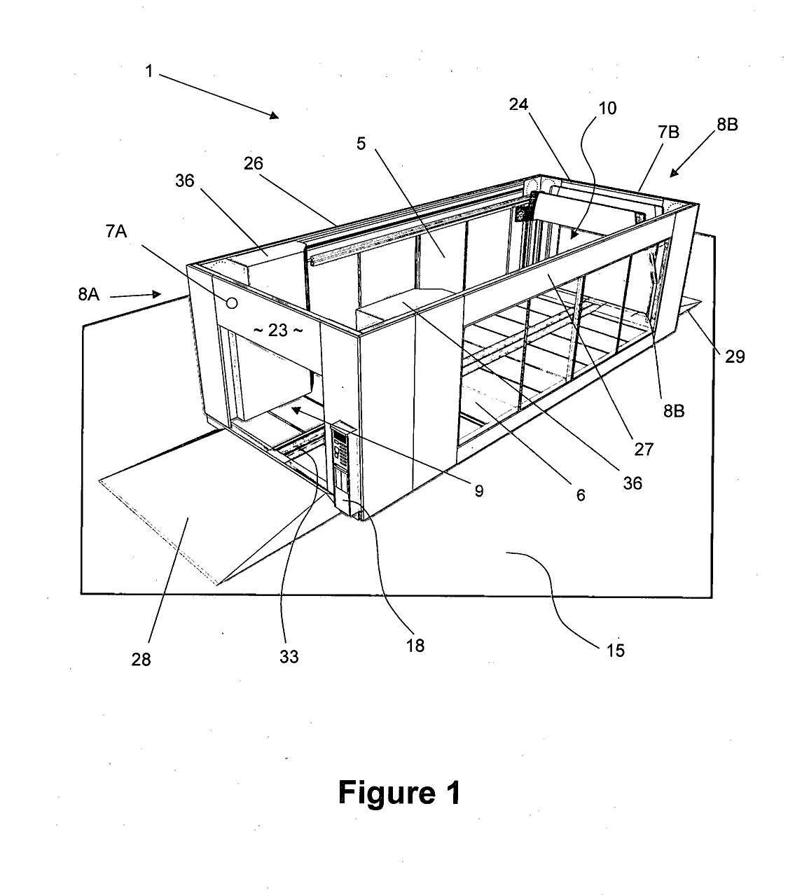

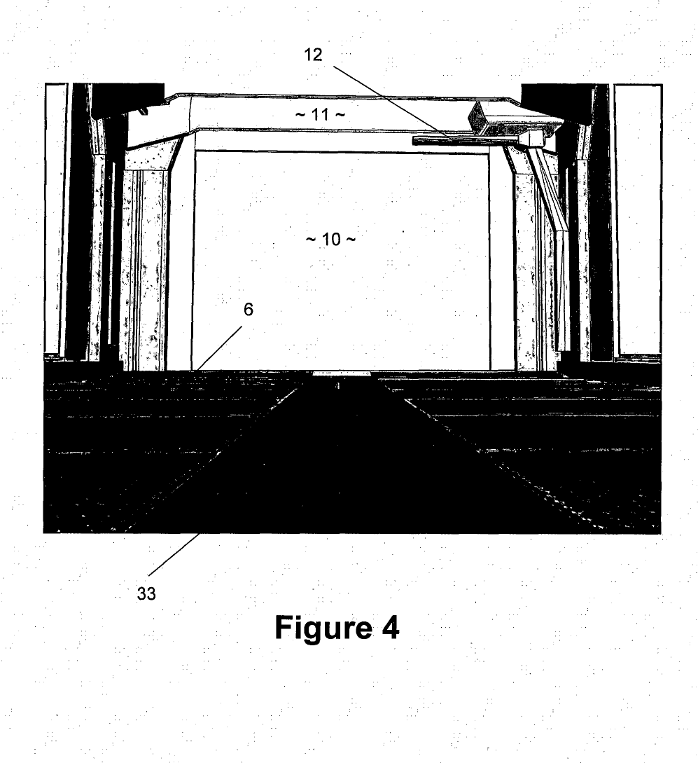

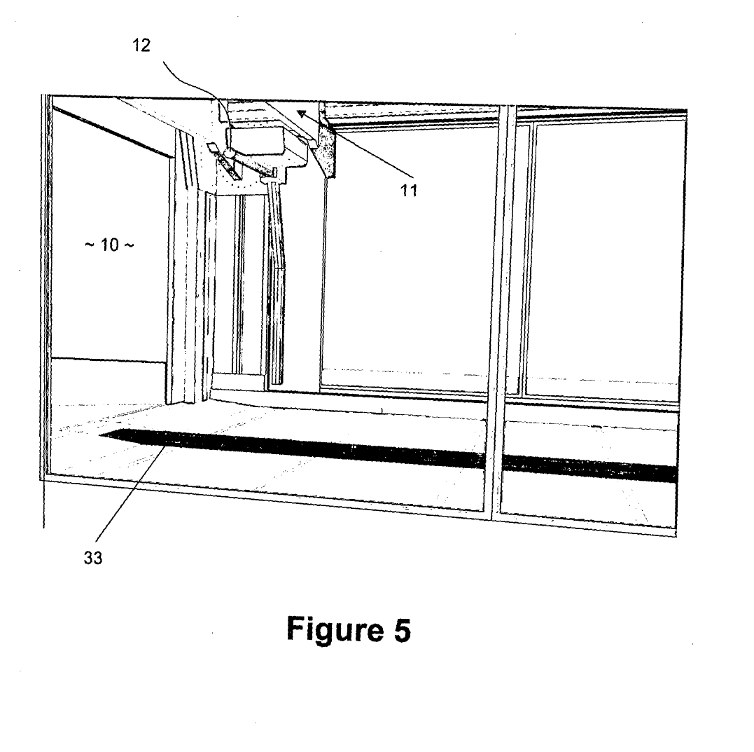

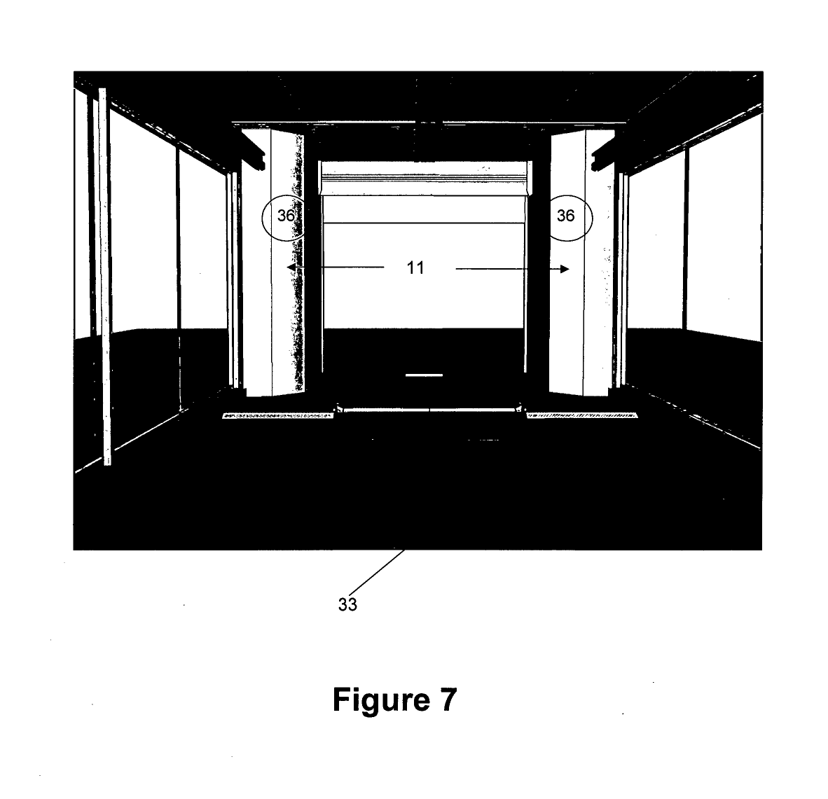

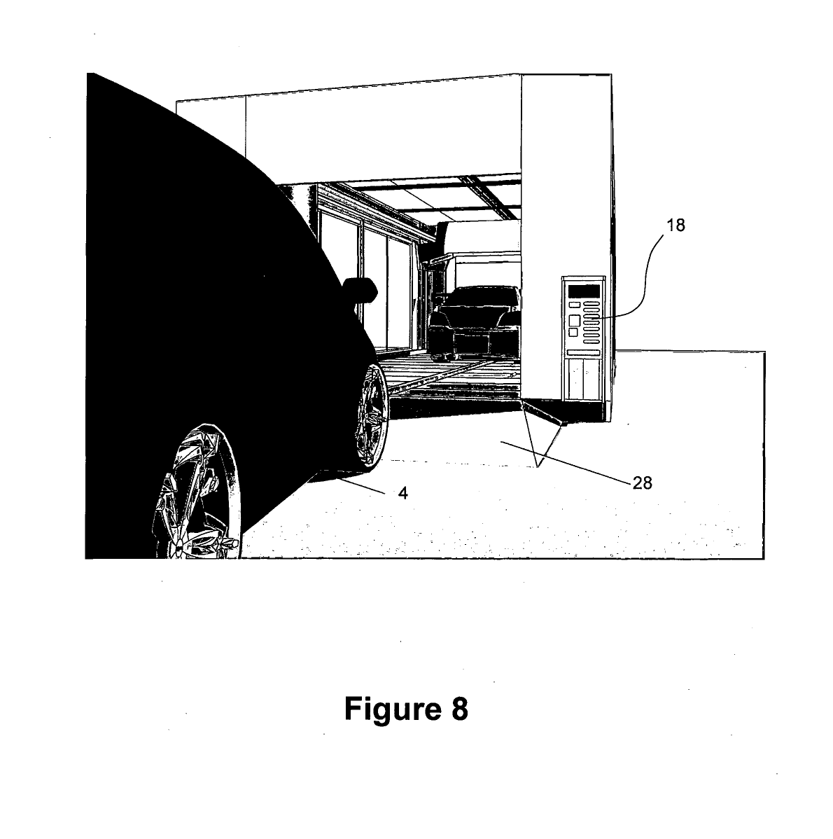

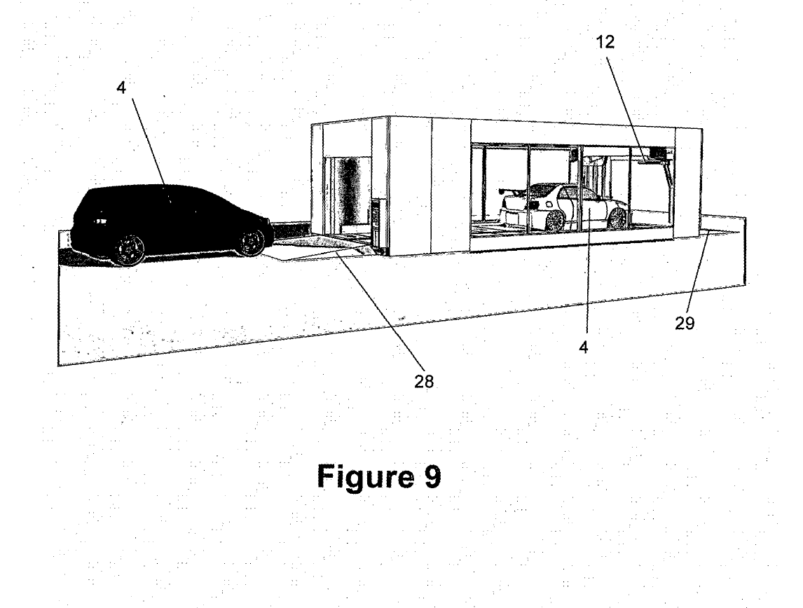

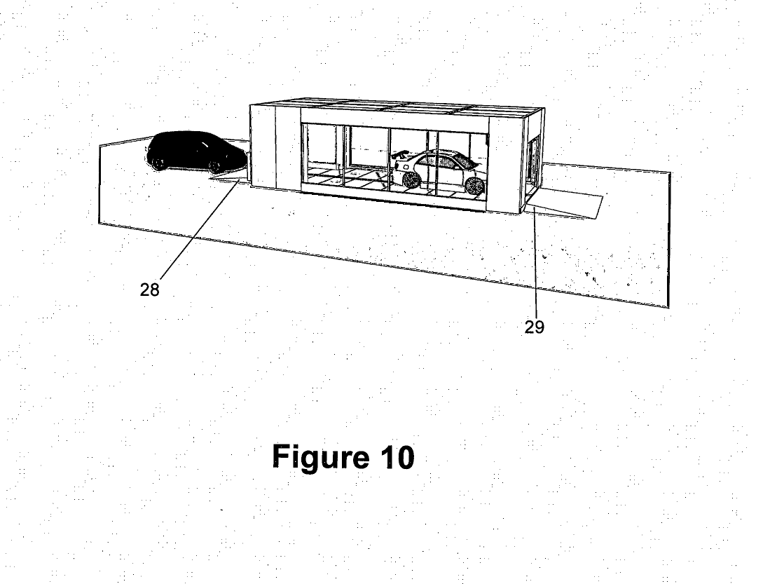

Preferred embodiments of the present invention are described below with reference to FIGS. 1 through 10.

A vending apparatus 1 is shown in FIG. 1. The vending apparatus 1 has a washing housing 5 that has a floor 6 and the washing housing has at least two walls 7A and 7B. As shown in the preferred embodiment in FIG. 1, these walls are at opposing sides 8A and 8B of the floor 6 as a first end wall 23 and a second end wall 24. These walls exist at the narrower sides of the washing housing 5, when the washing housing 5 has a rectangular plan section. In other embodiments of the present invention the at least two walls may be present in opposing long sides of the floor 6.

At opposing ends of the washing housing 5 there is an entrance aperture 9 and an exit aperture 10. These may be defined by apertures in the first end wall 23 and second end wall 24. Equally they may be defined by the presence of the first side wall 26 and a second side wall 27 in the absence of end walls, for example when the first and second end walls 23 and 24 respectively are not present.

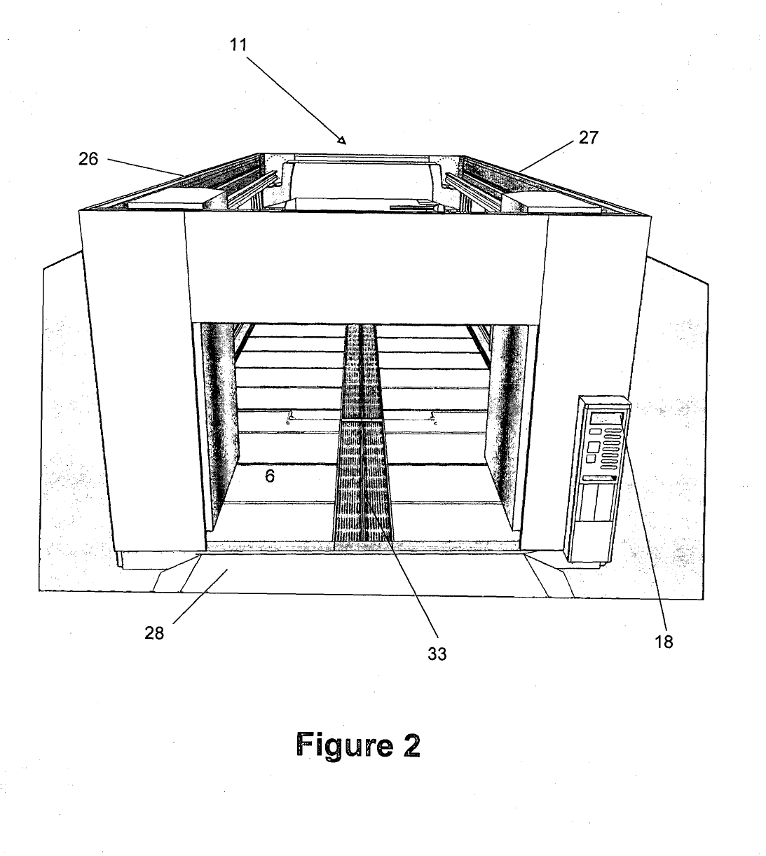

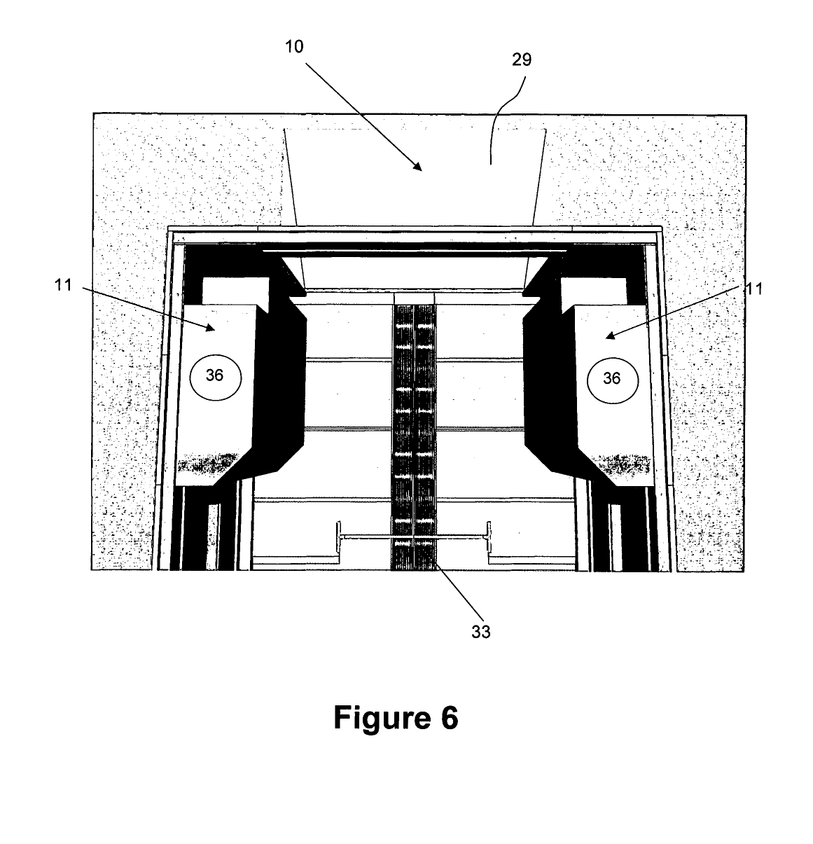

Shown in FIGS. 2, 3, 4, 5 and to some extent in FIGS. 6 through 9, is the washing apparatus 11. In the preferred embodiment, the washing apparatus 11 is of the touchless variety in that the washing apparatus 11 guides a touchless wand 12 about a vehicle 4 when it is located in the washing housing 5. Such washing apparatus 11 insofar as it guides a touchless wand 12 is known and relies upon existing technology to guide the touchless wand 12 or other such washing delivery apparatus around the vehicle 4. The touchless wand 12 or other apparatus as it moves around the vehicle 4 delivers cleaning fluids.

Other forms of washing apparatus 11 may be of a touch variety, such as, but not limited to, a brushed type.

Such cleaning fluids may be a mixture of water and special chemicals to clean a vehicle. In other situations it may be just water for rinsing or just chemicals. The touchless wand 12 or similar apparatus is also enabled to deliver a drying gas to the vehicle 4, for example warm or dehumidified air onto the vehicle to remove residual fluid that is on the vehicle 4 during or after cleaning.

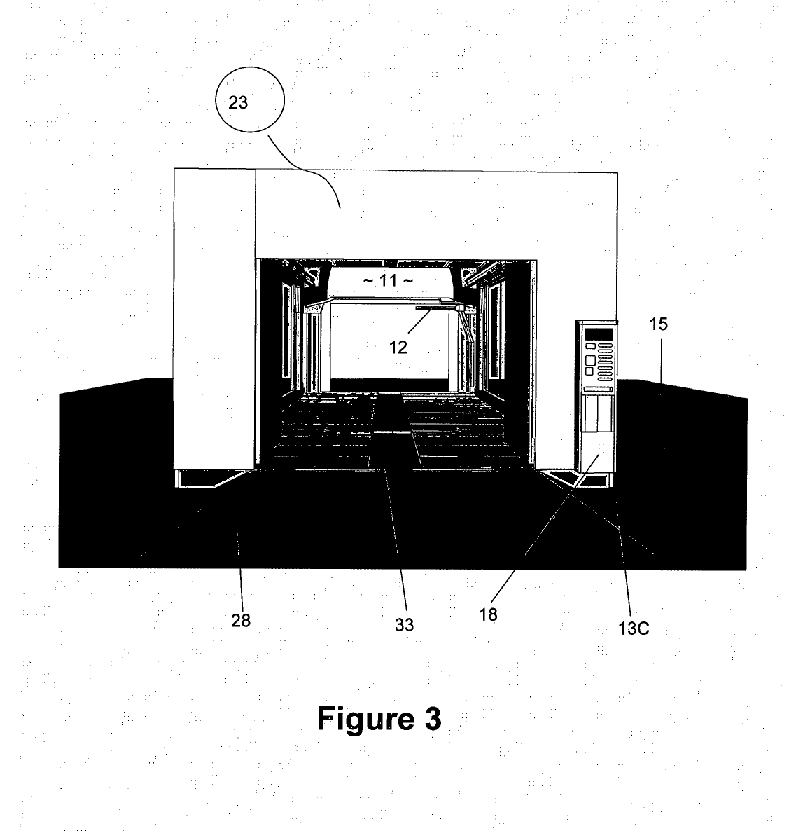

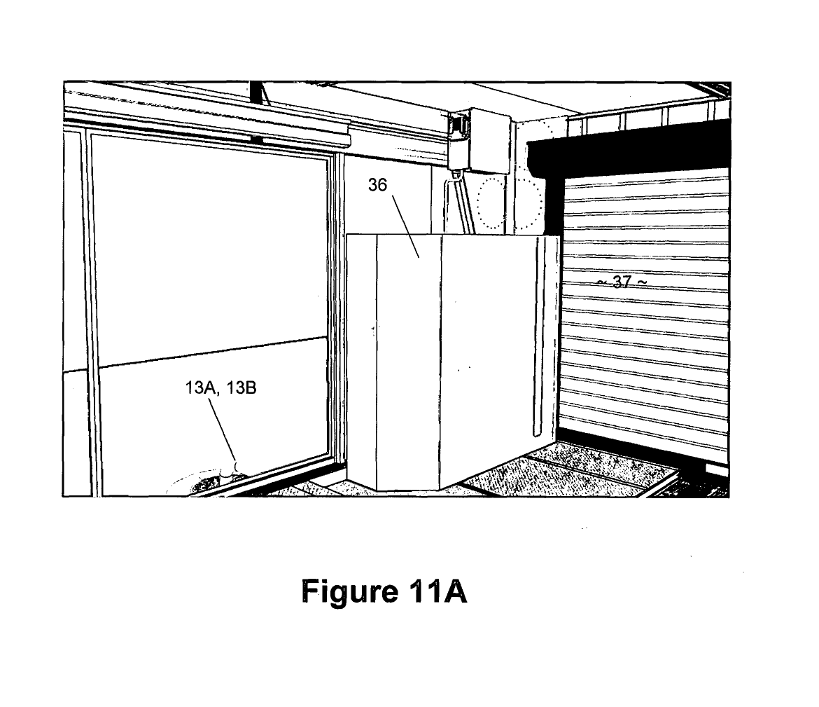

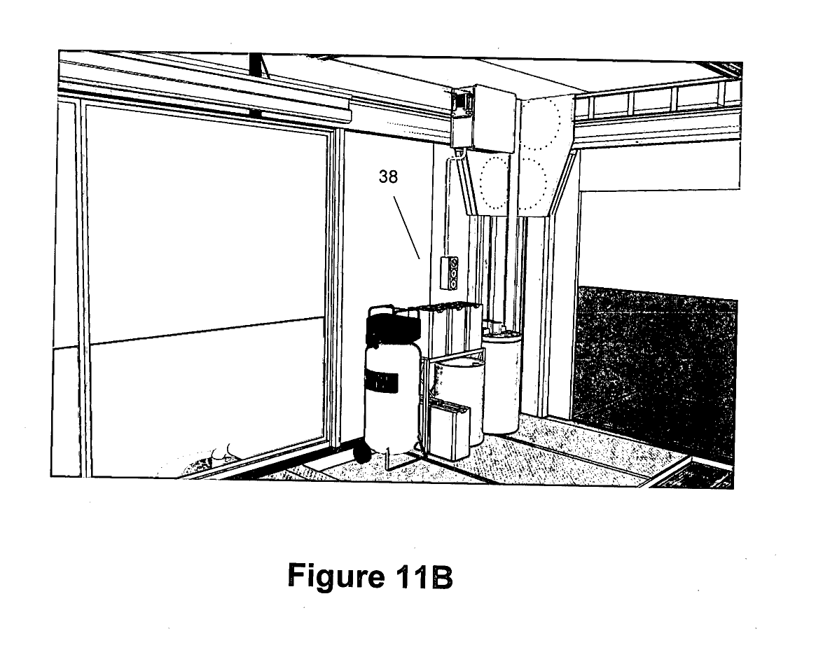

Located at or near a peripheral point of the washing housing 5 is at least one connection point, as shown in FIG. 3 to connect the utilities required, such as power, fluids in, fluids out and control telemetry. In the preferred embodiment, the connection point is at least a connection point for fluid supply 13A, fluid removal 13B (shown in FIG. 11A) and power 13C. In the preferred embodiment the fluid supplied to the vending apparatus is just water and all other washing chemicals and similar are on board the vending apparatus 1. However, in other embodiments there may be a separate storage of washing chemical(s) that is not within the vending apparatus 1 and this may be supplied by a further fluid supply connection or entrained in the first fluid supply connection 13A. The power connection 13C to the vending apparatus 1 in the preferred embodiment is an electrical connection to power the vending apparatus, washing apparatus, and other components such as closing and opening of the entrance and exit apertures, such as for example by the ramps 28 and 29 or other doors (not shown). However, in other embodiments a working fluid may be supplied such as hydraulic fluid, for example hydraulic oil, water, or even air under pressure. In other embodiments a number of connections may be present to power the vending apparatus, for example, electrical power for the electrical requirements, hydraulic fluid for activation of some components, compressed air or other gas for other components, and or drying.

The exact mix of connections, power and fluid required will depend on the washing apparatus installed. The washing apparatus for example may only need power and water connections.

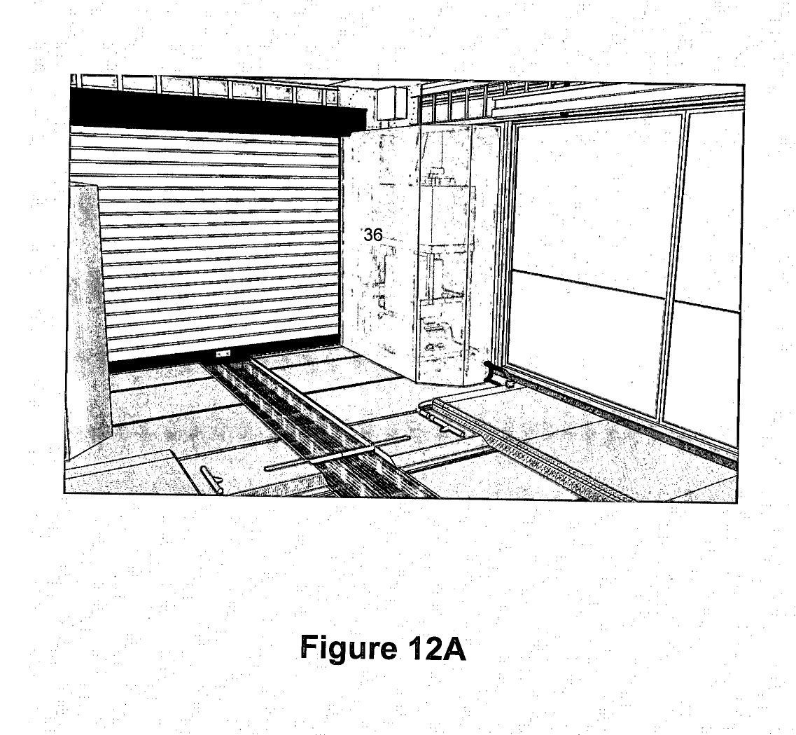

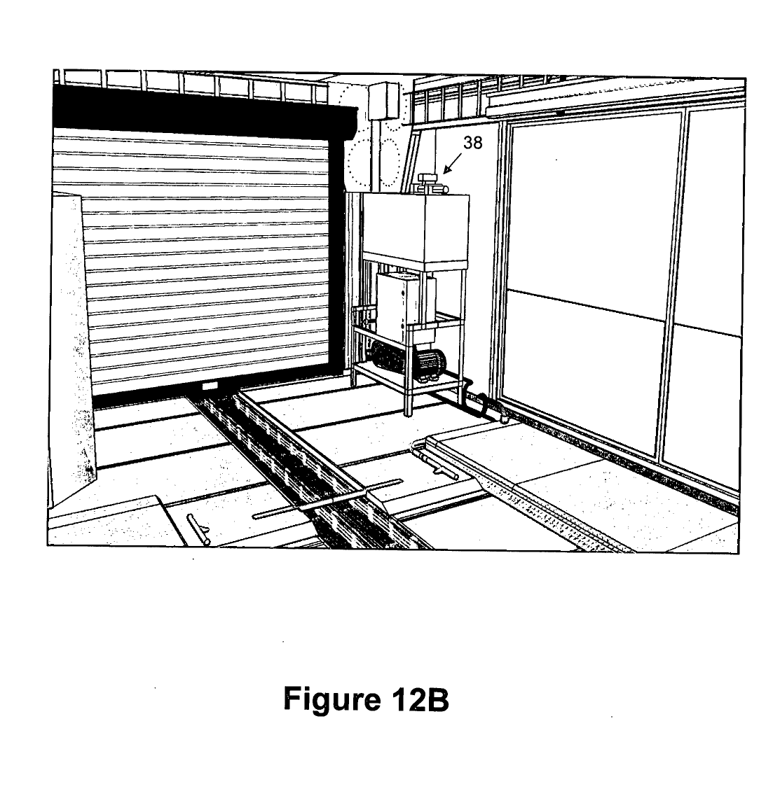

The washing apparatus 11 in the preferred embodiment is substantially retained behind apparatus cowls 36 as shown in FIGS. 1, 6 and 7 and 11A, 11B, 12A, 12B. The apparatus cowls 36 protect the otherwise delicate mechanicals, prevent them being interfered with, prevent contamination and give a clean look. In the preferred embodiment, these apparatus cowls 36 and the washing apparatus 11 they contain are located towards the entrance aperture 9 of the washing housing 5. However, in other embodiments they may be located anywhere convenient, for example both on one side of a wall, or may be distributed throughout any convenient location, for example under the floor, in the ceiling or down one side or other similar locations. Those parts of the washing apparatus 11, for example guide rails and mobile elements are of course not contained behind the apparatus cowls 36 but run the length of the washing housing 5 as required.

Because the floor 6 has at least some thickness, then ramps are required as shown in FIGS. 1, 2, 3, 6, 8, 9 and 10. An entrance ramp 28 is present at the entrance aperture 9 to allow a vehicle to come up to the same height as the floor 6 and pass into the washing housing 5. Similarly, at the exit aperture 10 there is an exit ramp 29 as shown in FIGS. 1, 6, 9 and 10. The exit ramp allows the vehicle 4 to exit the exit aperture 10 from the height of the floor 6 onto the surrounding ground 15, onto which the vending apparatus 1 is located when in use.

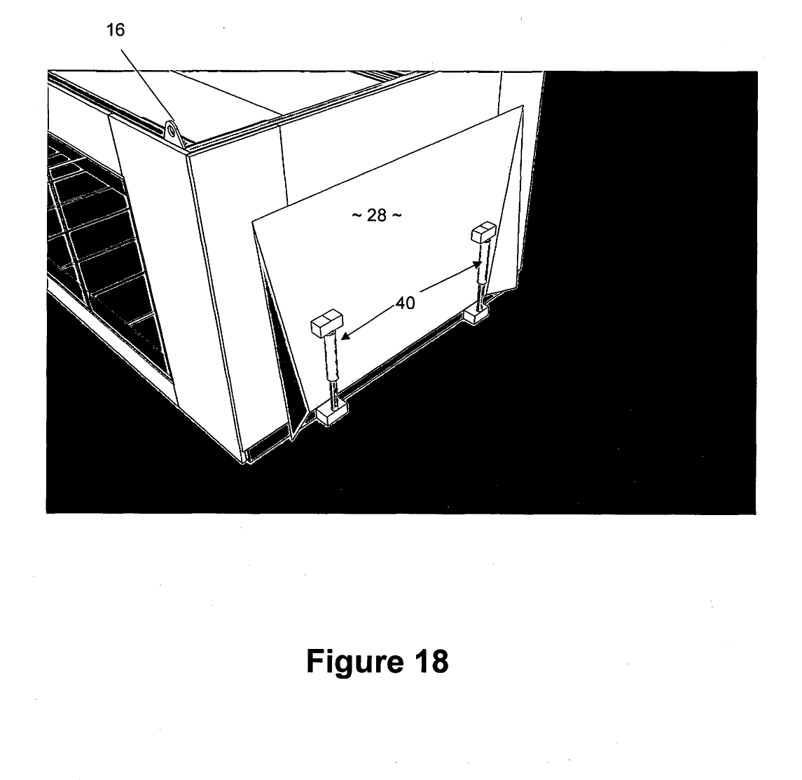

In one preferred embodiment of the present invention the entrance ramp 28 and exit ramp 29 can fold up to at least in part close off the entrance aperture 9 and exit aperture 10 respectively as shown in FIGS. 18 through 20. The ramps articulate at or near their bottom and can move from a first position where they act as ramps to a second position where they close off their respective apertures. The movement of the ramps can be effected in a number of ways known in the art and can be manual or automatic. One example of closing means is shown, using hydraulic rams 40.

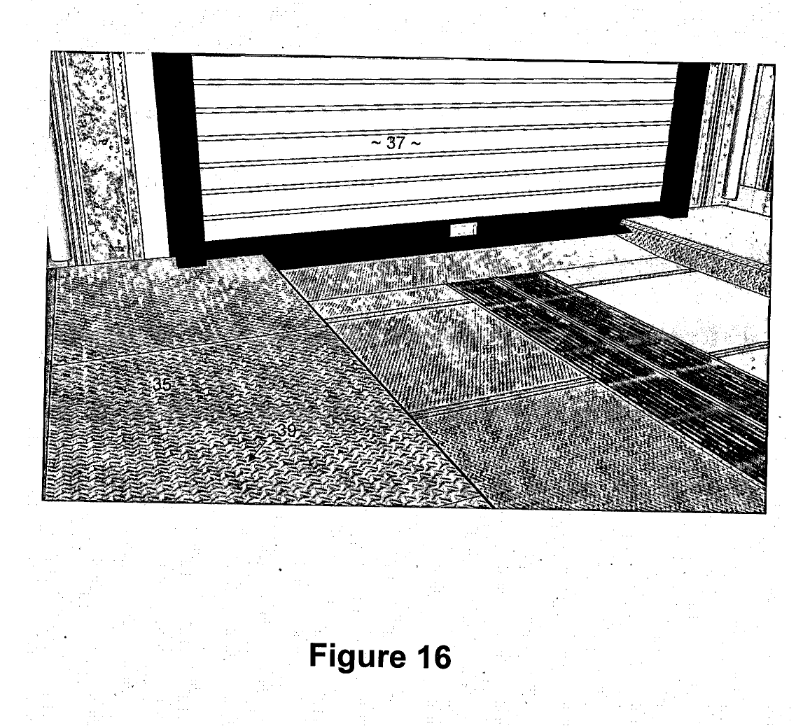

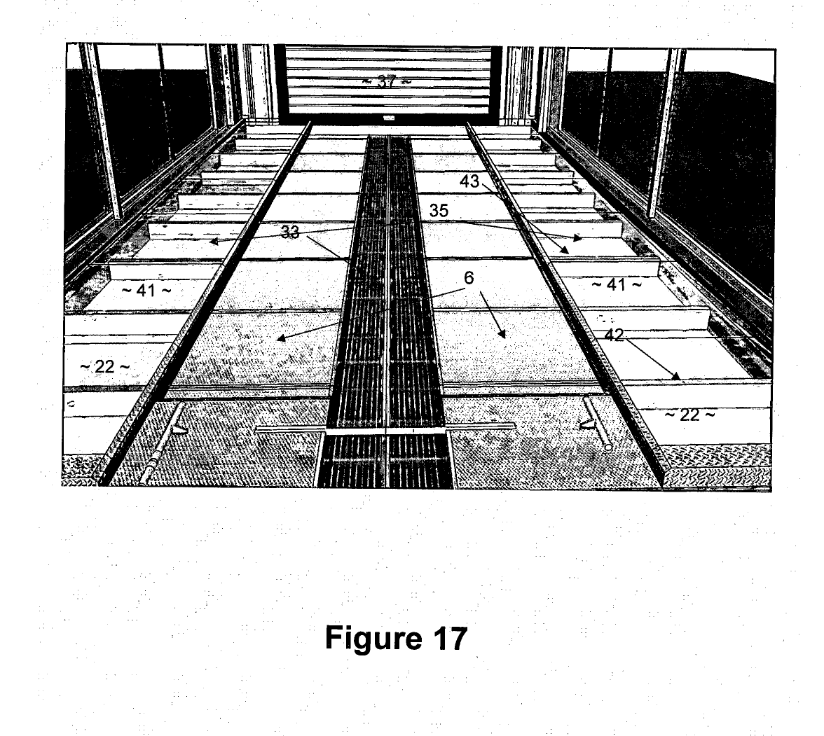

Alternatively, or in addition there are doors 37 as shown in FIGS. 16 and 17. These may be, sound, water and/or spray proof, or tamperproof that close off the entrance and exit apertures.

The ramps may also be separate structures that do not fold up and down. In this situation they maybe formed from the surrounding location, for example concrete, steel or similar.

Folding up in this way serves several purposes. The ramps can fold up to minimise the footprint of the vending apparatus 1, for example when it is being transported (for example as shown in

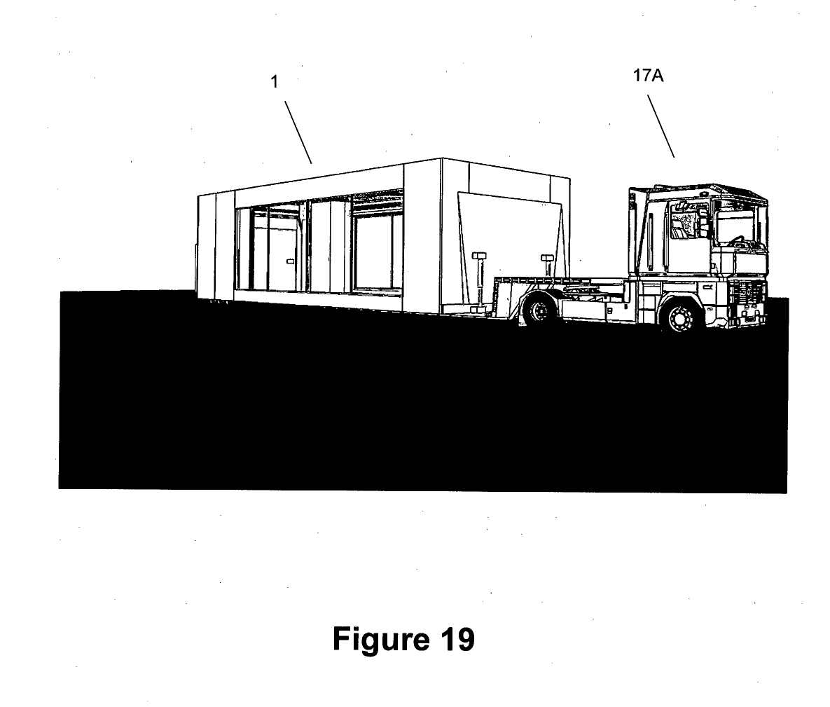

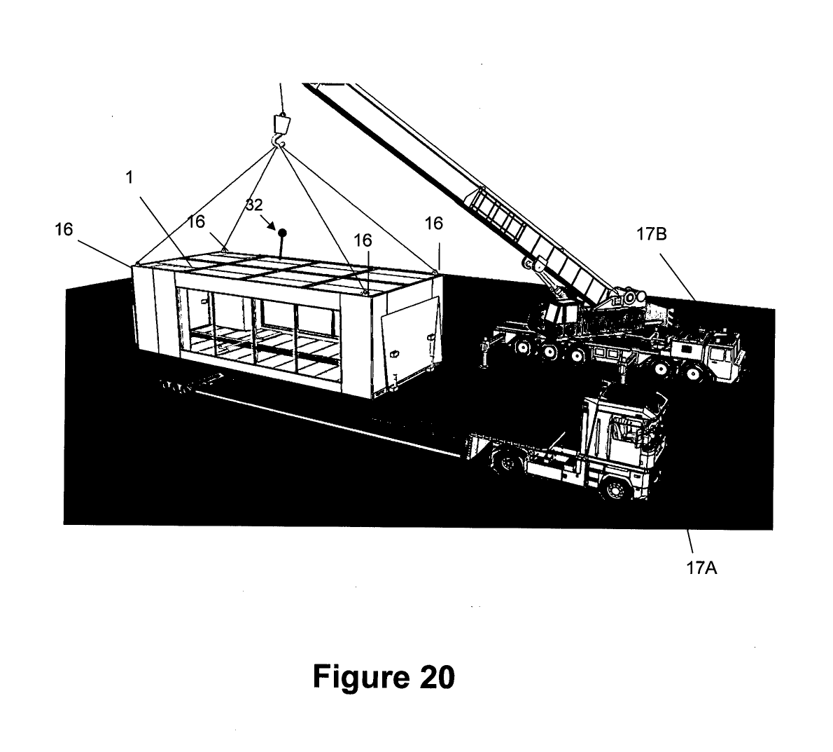

FIGS. 19 and 20). In addition the ramps can prevent access to the interior of the vending apparatus when folded up. This may be desired when the vending apparatus is in storage, in transport, or for security purposes for example overnight when not in use. In addition they may fold down to allow entrance of a vehicle for washing, and fold up while the vehicle is in the wash phase to prevent other vehicles entering during the wash. The ramps may close overnight and open during the day, or open when a vehicle wash is to be vended, and then close again, not withstanding any secondary internal doors to contain spray and noise.

Such a security feature allows the vending apparatus 1 to operate in more remote areas than a normal commercial vehicle wash.

When the vending apparatus is in storage or transport the interior of the vending apparatus can be used to store additional components. If a water reclamation, storage and cleaning unit is to be used this can be located inside the vending apparatus during storage or transportation, if it is a separate unit. Other embodiments of the present invention have the water treatment apparatus 35 such as reclamation, cleaning and filtering located within the structure of the unit so no separate external structure is required. The water treatment apparatus may include tanks for storage of the fluids in full or part processed form for further processing or to be used in cleaning.

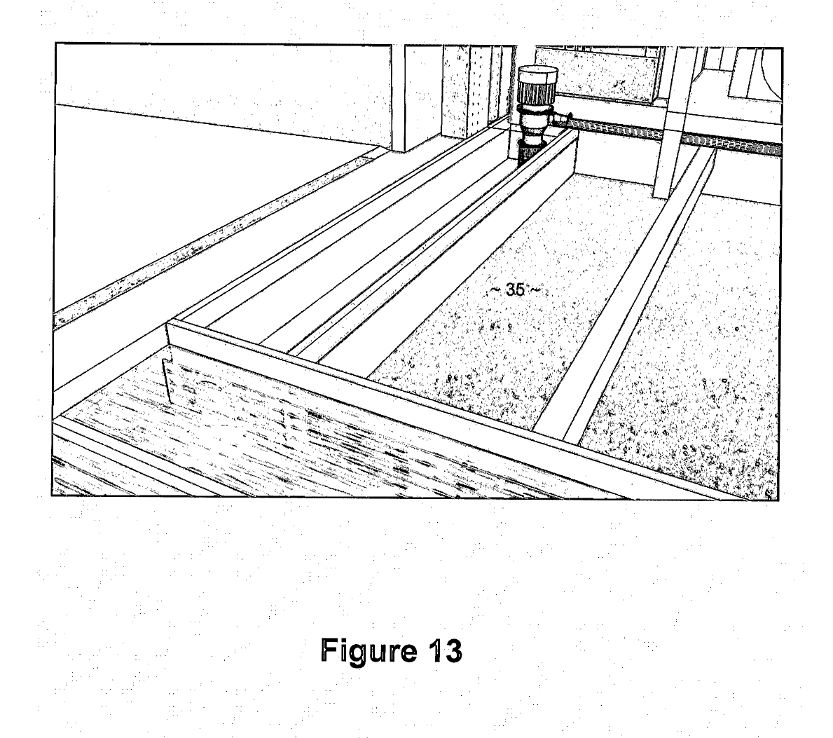

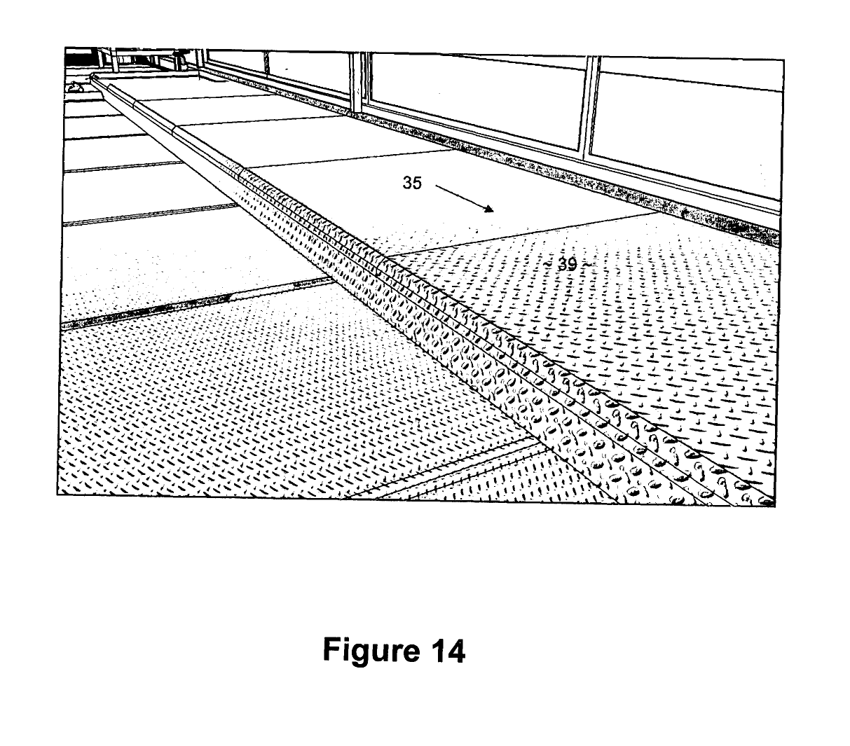

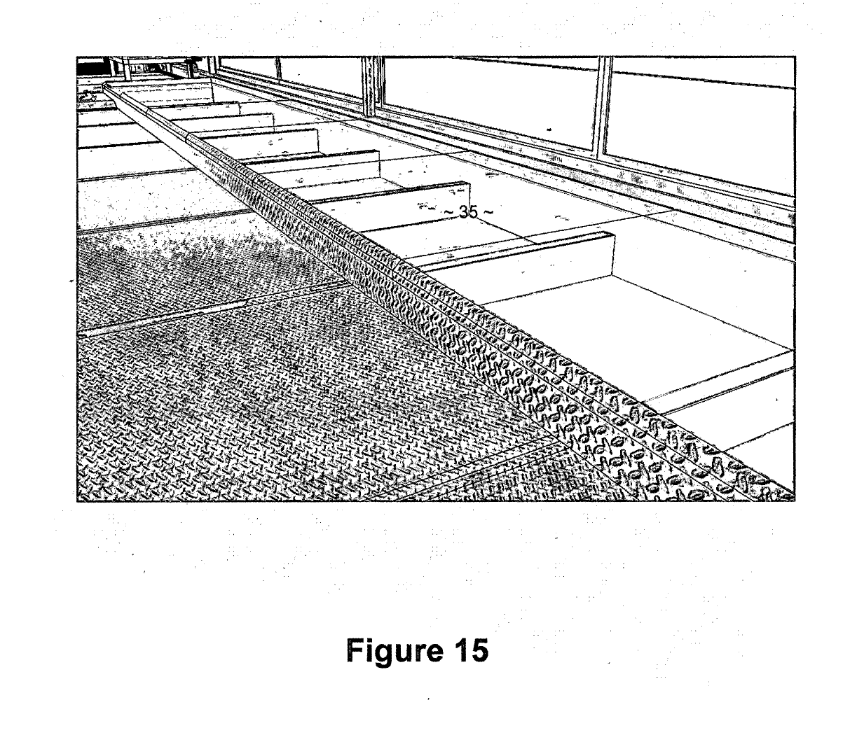

For example as shown in FIGS. 13 through 17 the floor 6 itself or the immediate periphery of the washing hall could contain a number of settling/interceptors, and further reclaim and treatment (for example reverse osmosis, ozone treatment etc) and storage may be in the walls, ceiling or other floor parts. Rain water may also be collected from the roof or other areas and stored. There may be covers 39 that can be removed to access the apparatus 35.

In one preferred form the water treatment apparatus 35 is preferably located on either side of the floor 6, as shown for example in FIG. 17 in collection channels 41. In the preferred form these channels 41 are joined at one end to form one large collection channel 41. The collection channel 41 in turn is feed waste fluids from the waste fluid collection channel 33. The water treatment apparatus 35 includes at least one, and preferably many baffles 43 and weirs 42 as shown. The baffles and thus define a number of tanks 22. The baffles 43 may be used to hold foam or similar floating debris in one tank, and the weirs 42 may be used to confine heavy or other materials in another of the tanks.

It is envisaged for movement that bulk fluids are removed from the unit prior to moving from one location to the next. These may be disposed or, or may be simply stored and relocated in the unit once it has been moved.

Power for the unit may come from an external utility connection. In other embodiments there may be onboard power, such as from a generator, rectifier or inverter. Solar power and storage may also be used.

A waste fluid collection channel 33 is shown in FIGS. 1, through 8 and 17. In the preferred embodiment, this waste fluid collection channel 33 is located centrally on the longitudinal axis of the washing housing 5 running from or near the entrance aperture 9 to or towards the exit aperture 10. However, in other embodiments it may be an interrupted channel, or a central collection point in a portion of the floor 6. In a preferred embodiment the floor 6 is substantially flat, or has a slope to or towards the waste fluid collection channel or point 33 to encourage waste fluids to drain towards the channel 33. Similarly when there is a single collection point, such as a drainage grate or hole, then the floor 6 generally slopes toward that collection point.

Present on an external surface of the washing housing 5 is a customer interface 18. In the preferred embodiment as shown in FIGS. 1, 2, 3, 8 and 9, it is on one side of the entrance aperture 9, and preferably it is located on the same side as the driver is located for the vehicle to be washed. The customer interface contains all or some of the control electronics for the washing apparatus 11, or at the very least is the initiation mechanism for the washing apparatus 11 to start its washing cycle. This may be stand alone at the entrance, attached nearby, for example at the start of the ramp, or remotely located, for example in an adjoining building, such as a service station. The customer interface or initiation mechanism may also be remotely connected and control wireless so no physical connections need be made.

Initiation may be made by paying, authorising payment, or by use or a pre-paid or loyalty card, debit card or similar.

Other vending apparatus may also be attached for example further cleaning products, food products, and cleaning services (for example vacuum) or similar.

The customer interface 18 and vending apparatus 1 generally may also optionally have a telephone or internet connection 32, whether wired or wireless. This allows control and remote monitoring of the state of the vending apparatus. For example when it is damaged, in a fault condition, worn, fluid levels are low or empty or requires special or regular maintenance. Such a connection may also allow video monitoring and use of electronic debiting or crediting methods for example from credit or EFTPOS cards, or debiting of specific prepaid wash cards. The user interface 18 and telephone connection 32 also allow for use of loyalty cards.

In FIGS. 19 through 20 there is shown movement of the apparatus 1 by a prime mover 17A, such as a truck and trailer unit and shown. This may be from the assembly site or from one desired installation site to the next. The apparatus 1 is designed such that it can be lifted or moved as a complete or substantially complete unit, as shown in FIG. 20 where a second prime mover 17B shown as a crane, lifts the apparatus 1 into and out of position via the engagement points 16. Other alternatives may be that the apparatus has all or part of its movement ability built in. For example it may just need attachment of wheels (or they may be in place) and hooking up to a prime mover to move it as a trailer type arrangement from one location to the next.

The unit in operation may be completely stand alone (whether fully contained or having additional units), such that no external connections are required.

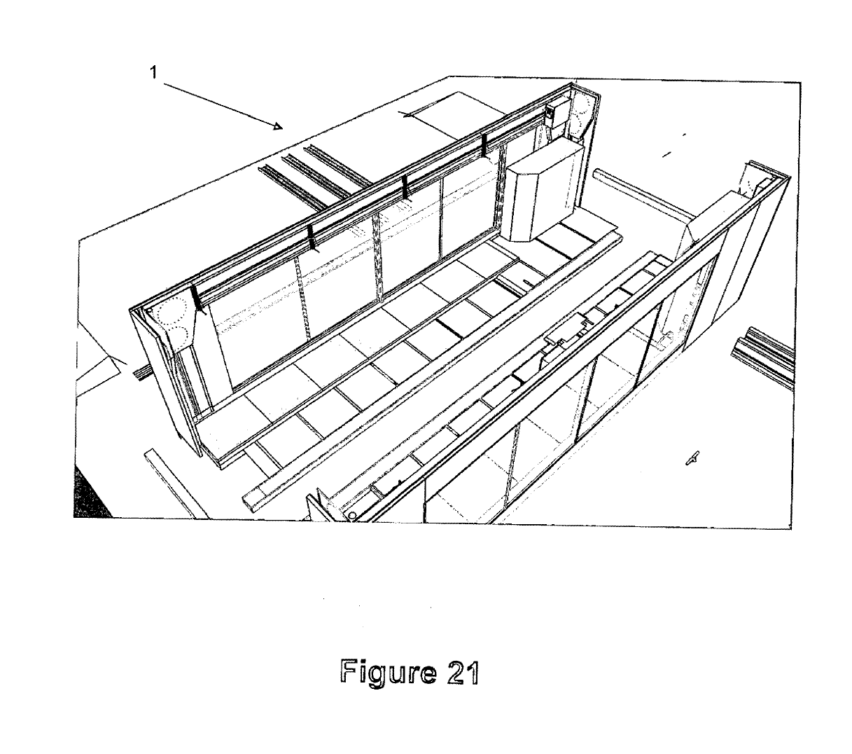

If necessary (for example because of roading size restrictions) the apparatus 1 can be broken down into 2 or more discrete components as needed, for example in half as shown in FIG. 21.

The apparatus 1 also may be shipped from its manufacturing point to its assembly point as a flat pack unit. Assembly, as shown in FIG. 1 of the apparatus 1 is then done. Such assembly may be done at the desired installation site, or is done off site and transported as shown in FIGS. 19 and 20.

Where, in the foregoing description, reference has been made to specific components or integers of the invention having known equivalents then such equivalents are herein incorporated as if individually set forth.

The foregoing description of the invention includes preferred forms thereof. Modifications may be made thereto without departing from the scope of the invention.

1.-57. (canceled)

58. A vending apparatus for vehicle washing that is substantially self contained and is adapted to be moved from one desired location to another as required, comprising or including,
a washing housing, said washing housing including,
a floor, and
at least two walls mounted to or from opposing sides of said floor, said at least two walls defining at least in part an entrance aperture and an exit aperture of said washing housing to allow passage of a vehicle, into said washing housing via said entrance aperture, onto and across said floor, and out of said washing housing via said exit aperture,
washing apparatus substantially contained within said washing housing that is automated to wash a vehicle when a vehicle is located in said washing housing,
a support surface or surfaces that depend from said washing housing to engage with and support said vehicle wash apparatus substantially above a ground or other surface it is located on,
at least one engagement point for a prime mover to allow movement of said apparatus from said location to another,
a customer interface to allow a customer to authorise and activate washing of a vehicle, and
water treatment apparatus at least in part contained in said washing housing, wherein said water treatment apparatus includes at least one baffle for fluid to flow under, and at least one weir for fluid to flow over,
wherein said washing housing can be located in a first location via said prime mover to allow washing of vehicles, and then when required can be easily moved via said prime mover to another location.

59. Apparatus according to claim 58 having at least any one or more of the following on board,
fluid supply,
fluid cleaning,
power,
telemetry,
telecommunications, and
control for said washing housing and washing apparatus.

60. Apparatus according to claim 58 wherein said vending apparatus before or after location in said location can be moved as a substantially erected self contained vending apparatus.

61. Apparatus according to claim 58 wherein said washing housing consists of at least two halves that split along a centrally located vertical plane running from said entrance aperture to said exit aperture to allow for easy transport of said vending apparatus from one location to another.

62. Apparatus according to claim 58 wherein said washing housing has at least one of an entrance ramp and an exit ramp to enable vehicle access thereto and exit therefrom and at least one of said entrance ramp or exit ramp has a first position and a second position, wherein said first position allows access or exit of a vehicle into or from said washing housing, and wherein said second position disallows access or exit from said washing housing.

63. Apparatus as claimed in claim 62 wherein in said second position said entrance ramp and/or exit ramp substantially close said entrance aperture and said exit aperture respectively.

64. Apparatus as claimed in claim 58 wherein there is at least one waste fluid collection channel running from at or near said entrance aperture toward said exit aperture, said at least one waste fluid collection channel being fed fluids at least from said floor after washing said vehicle.

65. Apparatus as claimed in claim 64 wherein said at least one waste fluid collection channel runs substantially underneath said floor.

66. Apparatus as claimed in claim 58 wherein said water treatment apparatus includes water storage means.

67. Apparatus as claimed in claim 58 wherein said water treatment apparatus is substantially contained under said floor.

68. Apparatus as claimed in claim 58 wherein said water treatment apparatus at least in part is located in two said collection channels running parallel to each other either side of said floor.

69. Apparatus as claimed in claim 68 wherein said two channels are connected at least one end thereof to form one channel.

70. Apparatus as claimed in claim 69 wherein said fluid removal via said fluid collection channel and said fluid supply and is to and from said water treatment apparatus.

71. Apparatus as claimed in claim 58 wherein said washing housing is substantially fully enclosed, at least when washing said vehicle, such that a minimum of fluids and washing debris escape said apparatus.

72. A method of vehicle wash vending, comprising or including the steps of,
(i) locating a self contained vending apparatus for vehicle washing in a desired location via one or more prime movers,
(ii) connecting any utilities required,
(iii) locating in place or attaching any vehicle access ramps to and from said vending apparatus, and
(iv) commissioning said vending apparatus by at least, powering up said self contained vending apparatus,
thereafter said self contained vending apparatus is in place to allow a user to wash a vehicle as required, when the location is no longer convenient or another location is desired the self contained vending apparatus can be,
(v) repositioned by reversing the above steps,
wherein said self contained vending apparatus comprises or includes,
a washing housing to substantially contain a vehicle when being washed, said washing housing including,
an entrance aperture thereto, and
an exit aperture therefrom for said vehicle, and
washing apparatus substantially contained within said washing housing that is automated to wash said vehicle when said vehicle is located in said washing housing, and
water treatment apparatus at least in part contained in said washing housing, wherein said water treatment apparatus includes at least one baffle for fluid to flow under, and at least one weir for fluid to flow over.

73. A method as claimed in claim 72 wherein said apparatus has at least any one of the following utilities on board,
fluid supply,
fluid removal,
power,
control or
telemetry/telecommunication.

75. A method as claimed in claim 72 wherein said self contained washing apparatus can be moved substantially as one piece from one desired location to the next.

76. A method as claimed in claim 72 wherein said washing housing consists of two parts that split along a centrally located vertical plane running from said entrance aperture to said exit aperture to allow for easy transport of said self contained vending apparatus from one location to another.

77. A method as claimed in claim 72 wherein including the step of folding said vehicle access ramps fold down to allow access or exit of said vehicle into or from said washing housing, or up to disallow said vehicle access or exit from said washing housing.

78. A kit of parts for a vending apparatus for vehicle washing, whether in flat pack and/or partially assembled form, wherein said kit enables assembly of a washing housing comprising or including,
a floor, and
at least two walls able to be mounted to or from opposing sides of said floor, said at least two walls when assembled defining an entrance aperture and an exit aperture of said washing housing to allow passage of a vehicle, into said washing housing via said entrance aperture, onto and across said floor, and out of said washing housing via said exit aperture,
washing apparatus substantially contained within said washing housing that is automated to wash a vehicle when a vehicle is located in said washing housing,
a support surface or surfaces that depend from said washing housing to engage with and support said vehicle wash apparatus substantially above a ground or other surface it is located on,
at least one engagement point for a prime mover to allow movement of said apparatus from said location to another,
a customer interface locatable in or on an external surface of said washing housing or closely located thereto to allow a customer to authorise and activate washing of a vehicle, and
water treatment apparatus at least in part for containment in said washing housing, wherein said water treatment apparatus includes at least one baffle for fluid to flow under, and at least one weir for fluid to flow over,
wherein said washing housing once assembled can be located in one location via said prime mover to allow washing of vehicles, and then when required can be easily moved via said prime mover to another location.
